(19) United States
(12) Patent Application Publication
(10) Pub. No.: US 2008/0073596 A1
(43) Pub. Date: Mar. 27, 2008

(54) Lithographic apparatus and method

(75) Inventors: Antonius Theodorus Anna Maria Derksen, Eindhoven (NL); Johannes Wangler, Koningsbronn (DE); David Christopher Ockwell, Waalre (NL); Peter Deufel, Konigsbronn (DE); Erik Matthias Sohmen, Aalen (DE); Wilhelm Ulrich, Aalen (DE); Johannes Zellner, Oberkochen (DE)

Correspondence Address: PILLSBURY WINTHROP SHAW PITTMAN, LLP, P.O. BOX 10500, MCLEAN, VA, 22102, US

(73) Assignees: ASML NETHERLANDS B.V., Veldhoven (NL); CARL ZEISS SMT AG, Oberkochen (DE)

(21) Appl. No.: 11/509,069

(22) Filed: Aug. 24, 2006

(51) Int. Cl. G01J 3/10

(52) U.S. Cl. 250/504 R

(57) ABSTRACT

A lithographic apparatus includes an illumination system configured to provide a beam of radiation, and a projection system configured to project the beam of radiation. The lithographic apparatus also includes a cooling system that is arranged to pass gas through the interior of the projection system such that the throughput of gas through the interior of the projection system is greater than 100 liters of gas per hour.

### FIELD OF THE INVENTION

The present invention relates to a lithographic apparatus and method.

### BACKGROUND OF THE INVENTION

Integrated circuits (ICs) are usually manufactured using lithography. A patterning device, which is alternatively referred to as a mask or a reticle, may be used to generate a circuit pattern corresponding to an individual layer of the IC. This pattern can be imaged onto a target portion (e.g. comprising part of, one or several dies) on a substrate (e.g. a silicon wafer) that has a layer of radiation-sensitive material (resist). In general, a single substrate will contain a network of adjacent target portions that are successively exposed.

Typically, a plurality of layers are provided on a substrate, each layer being processed to permanently fix the pattern in that layer before the next layer is formed. Once all of the layers have been formed and processed, the substrate is cut up into individual ICs and each IC is mounted on a board. Each board is provided with legs which are electrically connected to the IC, thereby allowing electrical signals to pass to and from the IC.

It has been conventional to use wires to connect an IC to a board. However, in recent years the distance between locations to which wires are to be bonded has become progressively smaller, and it has become more difficult to use wire bonding. A process which is known as flip-chip bumping is increasingly used to connect ICs to boards instead of using connection wires. In flip-chip bumping, solder (or some other metal) is provided at specific locations on each IC on a substrate. The substrate is inverted and bonded to a board. One method of bonding the substrate to the board is by heating the solder such that it melts, and then allowing it to cool. Alternative methods of bonding the substrate to the board include ultrasonic welding, mechanical pressure or using conductive paste. The board is patterned to provide a series of electrical contacts to separate portions of the IC via the solder bumps.

Lithographic apparatus may be used to apply a pattern of solder bump locations on the substrate, i.e. a lithographic apparatus may be a flip-chip bumping apparatus. The bump location pattern is applied to the substrate using a lithography mask.

Typically, a lithographic apparatus comprises a projection system in order to project a patterned projection beam of radiation onto a substrate. A projection system may comprise, for instance, a series of lenses, through which the projection beam passes. It is known that the projection system, and in particular the lenses may be heated by the projection beam. Such heating can distort the projected image, which could for instance cause solder bumps to be incorrectly located on the surface of the substrate.

It is an object of the present invention to overcome or mitigate the above mentioned disadvantages.

### SUMMARY OF THE INVENTION

According to a first aspect of the present invention, there is provided a lithographic apparatus that includes an illumination system configured to provide a beam of radiation, and a projection system configured to project the beam of radiation. The lithographic apparatus further includes a cooling system arranged to pass gas through the interior of the projection system such that the throughput of gas through the interior of the projection system is greater than 100 liters of gas per hour.

According to a further aspect of the present invention, there is provided a device manufacturing method that includes providing a beam of radiation using an illumination system, and projecting the beam of radiation with a projection system. The method also includes passing gas through the interior of the projection system such that the throughput of gas through the interior of the projection system is greater than 100 liters of gas per hour.

According to a further aspect of the present invention, there is provided a lithographic apparatus that includes an illumination system configured to provide a beam of radiation, and a projection system configured to project the beam of radiation. The lithographic apparatus further includes a cooling system arranged to pass gas through the interior of the projection system. The projection system includes one or more lens elements surrounded by an outer casing. The cooling system is arranged such that the gas is directed through the interior of the projection system from a first portion of the outer casing to a second portion of the outer casing remote from the first portion.

According to a further aspect of the present invention, there is provided a device manufacturing method that includes providing a beam of radiation using an illumination system, and projecting the beam of radiation with a projection system. The method also includes passing gas through the interior of the projection system. The projection system includes one or more lens elements surrounded by an outer casing. The cooling system is arranged such that the gas is directed through the interior of the projection system from a first portion of the outer casing to a second portion of the outer casing remote from the first portion.

According to a further aspect of the present invention, there is provided a lithographic apparatus that includes an illumination system configured to provide a beam of radiation, and a projection system configured to project the beam of radiation. The lithographic apparatus further includes a cooling system that is arranged to pass gas through the interior of the projection system such that the cooling system cools the projection system.

According to a further aspect of the present invention, there is provided a device manufacturing method that includes providing a beam of radiation using an illumination system, and projecting the beam of radiation with a projection system. The method also includes passing gas through the interior of the projection system such that the gas cools the projection system.

### BRIEF DESCRIPTION OF THE DRAWINGS

Embodiments of the invention will now be described, by way of example only, with reference to the accompanying schematic drawings in which:

FIG. 1 schematically shows a lithographic apparatus in accordance with an embodiment of the invention;

FIG. 2 is a flow diagram, which represents flip-chip bumping;

FIG. 3 schematically illustrates a known cooling system for a projection system forming part of a lithographic apparatus;

FIG. 4 schematically illustrates a cooling system for a projection system forming part of a lithographic apparatus, in accordance with an embodiment of the present invention;

FIG. 5 schematically illustrates a cooling system for a projection system forming part of a lithographic apparatus, in accordance with a further embodiment of the present invention;

FIG. 6 schematically illustrates a cooling system for a projection system forming part of a lithographic apparatus, in accordance with a further embodiment of the present invention; and

FIG. 7 schematically illustrates a cooling system for a projection system forming part of a lithographic apparatus, in accordance with a further embodiment of the present invention.

### DETAILED DESCRIPTION OF THE INVENTION

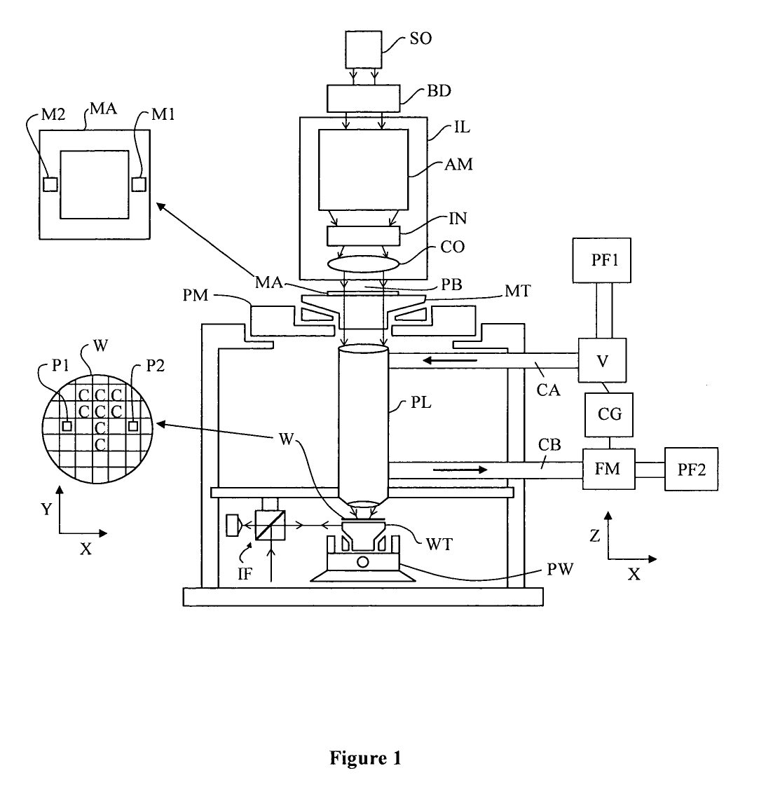

FIG. 1 schematically depicts a lithographic apparatus which embodies the invention. The apparatus comprises: an illumination system (illuminator) IL for providing a projection beam PB of radiation (e.g. UV radiation or EUV radiation); a first support structure (e.g. a mask table) MT for supporting a patterning device (e.g. a mask) MA and connected to a first positioner PM for accurately positioning the patterning device with respect to item PL; a substrate table (e.g. a wafer table) WT for holding a substrate (e.g. a resist-coated wafer) W and connected to a second positioner PW for accurately positioning the substrate with respect to item PL; and a projection system (e.g. a refractive projection lens) PL for imaging a pattern imparted to the projection beam PB by the patterning device MA onto a target portion C (e.g. comprising one or more dies) of the substrate W.

As here depicted, the apparatus is of a transmissive type (e.g. employing a transmissive mask). Alternatively, the apparatus may be of a reflective type (e.g. employing a programmable mirror array of a type as referred to above).

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising for example suitable directing mirrors and/or a beam expander. In other cases the source may be integral part of the apparatus, for example when the source is a mercury lamp. The source SO and the illuminator IL, together with the beam delivery system BD if required, may be referred to as a radiation system.

The illuminator IL may comprise an adjustor AM for adjusting the angular intensity distribution of the beam. Generally, at least the outer and/or inner radial extent (commonly referred to as σ-outer and σ-inner, respectively) of the intensity distribution in a pupil plane of the illuminator can be adjusted. In addition, the illuminator IL generally comprises various other components, such as an integrator IN and a condenser CO. The illuminator provides a conditioned beam of radiation, referred to as the projection beam PB, having a desired uniformity and intensity distribution in its cross-section.

The projection beam PB is incident on the mask MA, which is held on the mask table MT. Having traversed the mask MA, the projection beam PB passes through the projection system PL, which focuses the beam onto a target portion C of the substrate W. With the aid of the second positioner PW and position sensor IF (e.g. an interferometric device), the substrate table WT can be moved accurately, e.g. so as to position different target portions C in the path of the beam PB. Similarly, the first positioner PM and another position sensor (which is not explicitly depicted in FIG. 1) can be used to accurately position the mask MA with respect to the path of the beam PB, e.g. after mechanical retrieval from a mask storage area (e.g. a mask library), or during a scan. Mask MA and substrate W may be aligned using mask alignment marks M1, M2 and substrate alignment marks P1, P2.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. In this manner, the reflected beam is patterned.

The lithographic apparatus further comprises a pair of conduits CA, CB which are arranged to pass gas to and from the projection system PL. The gas is provided by a first port PF1 in a fabrication plant in which the lithographic apparatus is located. Typically the gas is provided at a pressure of between 5 and 10 bars. A valve V controls the supply of gas to the first conduit CA, thereby controlling the supply of gas to the projection system PL. A flow meter FM connected to the second conduit CB measures the flow of gas from the projection system. After the flow meter the gas may be returned to the fabrication plant's gas generation system via a second port PF2. A controller CG is connected to the flow meter and controls the valve V based on feedback from the flow meter.

Following projection of the pattern onto the substrate W, the substrate is processed. This is generally done in a track: a tool that develops the exposed resist (the track may also apply a layer of resist to the substrate before lithographic exposure). The developed resist is then further processed to provide the developed layer with desired electrical properties (for example by filling recesses of the pattern with a suitable semiconductor or metal). A plurality of layers is provided in this manner, the layers together forming integrated circuits (ICs). The term ‘substrate’ used herein is intended to include a substrate that already contains multiple processed layers.

Once the ICs have been formed on the substrate, the substrate is usually passed to a packaging foundry. The packaging foundry includes apparatus, which may be used to package individual ICs provided on the substrate. Each IC is mounted on a board, which has legs that are electrically connected to the IC. One way in which this may be done is by using solder bumps to provide connections to the IC, in a process, which is referred to as flip-chip bumping.

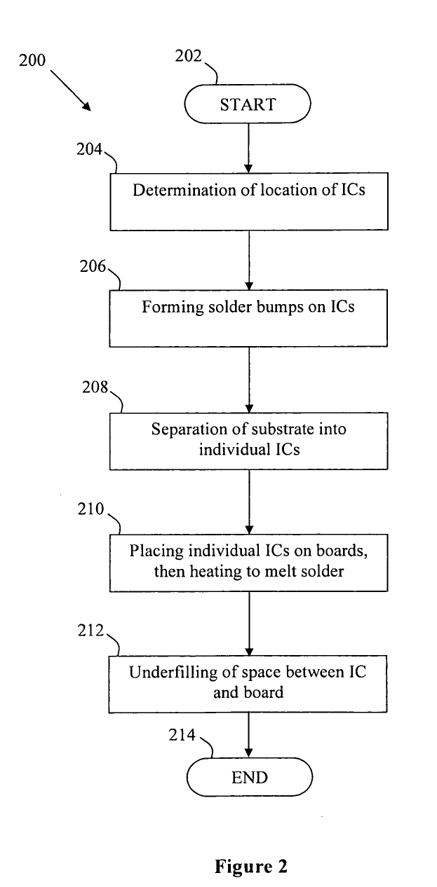

A flow chart which summaries a conventional flip-chip bumping process 200 is shown in FIG. 2. The process starts at 202. As 204, the locations of the ICs on the substrate are determined.

Following this, at 206, solder bumps are formed on the ICs. The solder bumps may be formed for example by lithography using the apparatus shown schematically in FIG. 1. The mask MA is provided with a pattern which comprises the desired location of the solder bumps. This pattern is imaged onto a thick layer of resist (i.e. thicker than a layer of resist used in conventional lithography) which is provided on the substrate. The substrate is then removed from the lithography apparatus and passed to processing apparatus. The resist is then developed and processed such that recesses are formed at the locations where solder bumps are needed. Solder is then electroplated in the recesses in the resist. The resist is then removed, so that solder bumps project upwards from the uppermost surface of the substrate.

In general, the resolution of the lithographic apparatus may be low, since the accuracy with which the solder bumps need to be located is typically around 1 micron (this is a significantly lower accuracy than the accuracy of tens of nanometers that is provided by high resolution lithographic apparatus). It will be appreciated that this description is not intended to be limited to any specific resolution (or range of resolutions).

Next, at 208, the substrate is cut up into individual ICs. This is done by cutting along specially provided tracks, known as scribe lanes, provided between the ICs.

At 210, a board is brought into contact with the solder bumps of a given IC, and the board and IC are heated so that the solder bumps melt and adhere to the board (the solder bumps continue to adhere to the IC). This provides a mechanical and electrical connection between the IC and the board. The heating may be performed for example by using a furnace. This part of the process may also include inverting the substrate such that the solder bumps are located beneath the substrate (the board being located beneath the solder bumps).

At 212, the space between the IC and the board (i.e. a gap defined by the height of the solder bumps) is filled with an adhesive or some other suitable material. This is known as underfilling and provides mechanical strength, in addition to protecting the solder bumps from moisture or other possibly damaging aspects of the surrounding environment. The flip-chip process ends at 214.

A projection system PL used within a lithographic apparatus used in a flip-chip process may comprise, for instance, a series of lenses, through which the projection beam passes. It is known that the projection system, and in particular the lenses may be heated by the projection beam. Such heating can distort the projected image by altering the refractive index of the lenses. This could for instance cause solder bumps to be incorrectly located on the surface of the substrate.

It is known to compensate the effect of distortion of the patterned projection beam by mechanically moving one or more of the lens elements within the projection system. In practice it has proved possible to reduce the effects of optical deviations from lens heating through mechanically adjusting the projection system or adjusting the imparted pattern. However, it has not proved possible to completely and reliably compensate for such distortions in this way.

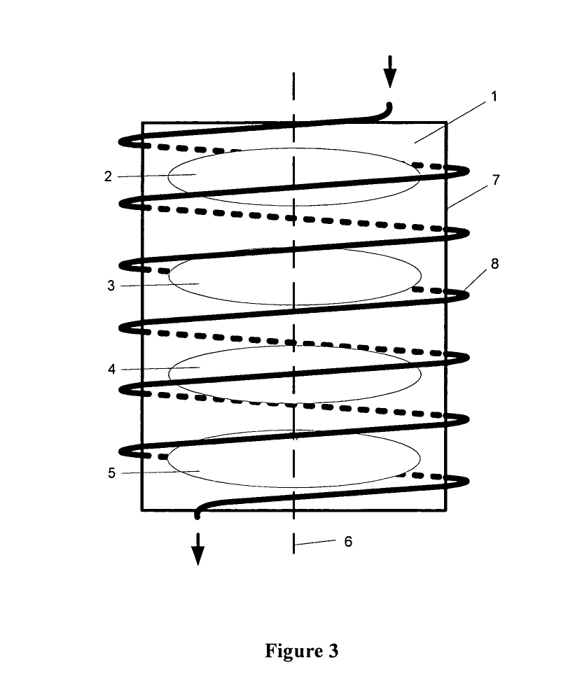

As an alternative approach to reducing optical distortions due to lens heating, it is known to externally cool a projection system. Referring now to FIG. 3, this schematically illustrates a known cooling system for a projection system. Projection system 1 is schematically illustrated as a series of lens elements 2-5, through which a projection beam of radiation is arranged to pass in a vertical direction indicated by dashed line 6. Lens elements 2-5 are contained within an enclosed exterior casing 7. It will be appreciated that appropriate portions of the exterior casing 7 will be transparent to the projection beam of radiation.

Surrounding the outside of the exterior casing 7 is an arrangement of piping 8. In FIG. 3 the piping 8 is shown as a spiral passing around the projection system 1. Those parts of the piping 8 passing behind the projection system 1 are shown as a dashed line. Water, or another coolant, is passed through piping 8, for instance through the spiral from top to bottom in the direction indicated by the arrows.

Piping 8 is arranged to be in thermal contact with the exterior casing 7 of the projection system 1, such that as the water passes through the piping heat is transferred away from the projection system 1. Water travelling away from the projection system 1 may be passed through a heat exchanger, and once cooled returned to the other end of piping 8 in order to form a closed loop cooling system. This process of cooling is alternatively referred to herein as thermostrating, or regulating the temperature of the projection system.

However, cooling the exterior casing 7 of the projection system 1 may be of limited effect in reducing heat induced optical deviations. As the cooling effect is from the exterior casing 7, heat transfer from the center portions of lens elements 2-5 is mainly through thermal conduction along the length of lens elements 2-5. The result is that there may be a thermal gradient along the length of the lens elements 2-5. A thermal gradient across a lens element may in fact cause greater distortion of the projected image than a projection system for which all of the lens elements are overheated by the same amount, and the heating is constant throughout the volume of each lens element.

It is known that the exterior casing of a projection system may comprise a substantially closed container in order to prevent airborne contaminants reaching the lens elements. As noted above, suitable portions of the exterior casing are formed from transparent materials in order to allow the passage of the projection beam. However, it is difficult to provide a completely sealed exterior casing and thus ensure that no airborne contaminants can reach the lenses. It is known to pressurize a gas inside the exterior casing, to a pressure slightly above the pressure of the gas surrounding the projection system. Thus, normally the gas inside the projection system is static, however in the event of a leak in the exterior casing, gas will pass from inside the projection system to outside the projection system. Airborne contaminants may be prevented from entering the projection system via any leaks by the gas escaping from the projection system. This process is known as purging. It will be appreciated that the volume of gas escaping from a projection system that is pressurized in this way is negligible, as the projection system is arranged to be as gas proof as possible. Furthermore, it will be appreciated that the flow of gas through a projection system is unpredictable as it is not usually possible to predict where leaks will occur.

In accordance with embodiments of the present invention an alternative cooling system for a projection system is provided. In accordance with embodiments of the present invention one or more (at most all) of the lens elements are cooled by passing a gas through the projection system. As such, the cooling effect may take place across a greater proportion of the surface of each lens element, thereby reducing thermal gradients throughout the lens elements and thus reducing distortion. In certain embodiments of the present invention this can provide a greater reduction in optical deviations due to lens heating than either known external cooling systems such as illustrated in FIG. 3, or mechanical or pattern compensation.

Furthermore, as well as reducing the overall degree of lens heating, embodiments of the present invention may also, or in addition, regulate the temperature throughout the projection system such that thermal gradients within the projection system, in particular the lenses, are reduced, independent of the absolute temperature of the projection system. This is advantageous as lens temperature variations can result in greater optical distortions, with the consequent effect on the image projected onto a substrate, that homogenous heating throughout the projection system, resulting in homogenous heating and variation in optical properties.

FIG. 1 schematically illustrates a lithographic apparatus which includes a cooling system in accordance with a first embodiment of the present invention. As described above, the pair of conduits CA, CB are arranged to pass gas to and from the projection system PL. The gas is provided by the first port PF1, typically at a pressure of between 5 and 10 bars. The valve V controls the supply of gas to the first conduit CA, thereby controlling the supply of gas to the projection system PL. The flow meter FM measures the flow of gas from the projection system. After the flow meter the gas returns to the fabrication plant's gas generation system via a second port PF2. The controller CG is connected to the flow meter, and controls the valve V based on feedback from the flow meter. This allows the flow of gas to the projection system PL to be controlled.

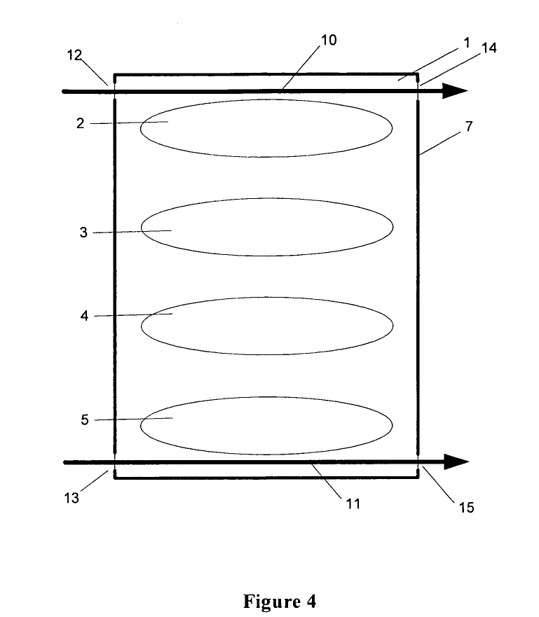

FIG. 4 schematically illustrates one way in which gas may be delivered to the projection system. In common with FIG. 3, projection system 1 comprises stacked lens elements 2-5 and exterior casing 7. Gas is passed through the inside of exterior casing 7 such that the lens elements 2-5 are directly cooled by the passing gas. The gas may be blown through, or sucked through the exterior casing 7.

In FIG. 4, the gas flow is schematically illustrated by arrows 10 and 11. Arrows 10 and 11 show the gas passing from inlets 12 and 13 to outlets 14 and 15 respectively. The flow of gas is shown passing adjacent to lens elements 2 and 5. It will be appreciated that it may be that the gas is only arranged to pass next to a single lens element.

The flow of gas next to a lens element is advantageous as it cools the lens elements across a large proportion of their surface area, thereby preventing the build up of thermal gradients. It will be appreciated that in alternative embodiments of the present invention, such as those described below, the gas may be arranged to flow past different or additional surface portions of the lens elements.

Depending upon the cooling requirements for a particular projection system 1, there are a range of aspects of the cooling system that may be optimized. Firstly, the volume of gas passed through the projection system can be adjusted. In certain embodiments of the invention the flow rate is greater than 100 liters per hour. The flow rate may be greater than 1000 liters per hour. An advantage of having a high flow rate is that the amount that the gas is heated by as it passes through the projection system may be reduced, such that it substantially retains its cooling capacity for those portions of the lens elements closest to the outlets. The speed of the gas flow may be adjusted, for instance in order to reduce vibrations within the lens elements. The number of gas inlets and outlets and their positions may be adjusted in order to determine which lens elements are cooled. In accordance with certain embodiments of the present invention, only those lens elements that are subject to the most heating are cooled.

Furthermore, the direction of gas flow may be optimized such that the gas passes the coolest lens elements first and then passes the hottest lens elements just before the gas leaves the projection system, in order to prevent heated gas being circulated. The gas used could be air. Alternatively, nitrogen or helium, or any other suitable gas may be used.

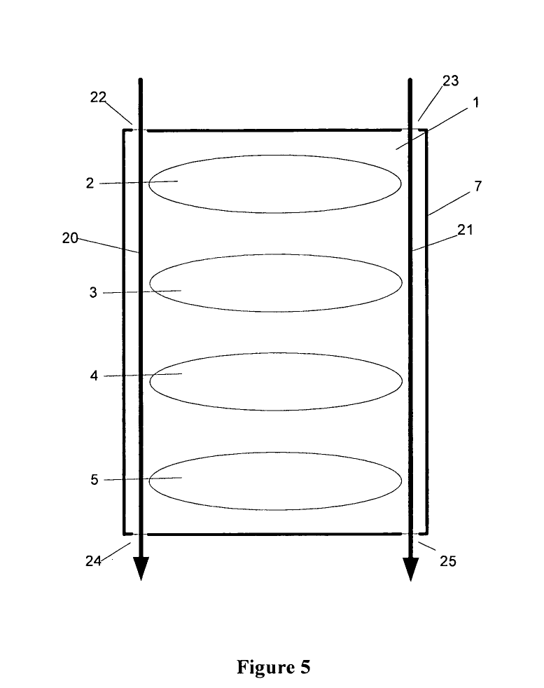

Referring now to FIG. 5, this schematically illustrates a projection system 1 with a cooling system in accordance with an alternative embodiment of the present invention. The projection system 1 is generally the same as for FIG. 4. However, this time the cooling system is arranged to pass gas through the projection system 1 in a vertical direction, indicated by arrows 20 and 21. The flow of gas is depicted in a downwards direction from inlets 22 and 23 to outlets 24 and 25 respectively. It will be appreciated that the flow of gas could be arranged to be in the opposite direction. The inlets 22 and 23 may be two of a multiplicity of inlets which are arranged in a circle around the top of the projection system. Providing a multiplicity of inlets reduces the amount of gas that is needed to flow through any given inlet, thereby helping to avoid excessive gas pressure being applied at a specific point or points on the uppermost lens element 2.

FIG. 5 is depicted in the same orientation as FIG. 1. That is, in FIG. 5, the top of the projection system 1 would be closest to the patterning device, and the bottom of the projection system 1 would be closest to the substrate. Due to transmission losses as the projection beam of radiation passes through the projection system, in certain embodiments of a lithographic apparatus it may be that for those lens elements closest to the patterning device the projection beam is at a higher intensity, and thus subjected to a greater degree of heating, than those elements closer to the substrate. For such an embodiment of the present invention, the optimal direction of gas flow would be upwards, such that the hottest lens elements are encountered last. For lithographic apparatus in which the projection beam is reduced (i.e. demagnified) as it passes through the projection system, it may be that the local intensity of the projection beam increases towards the substrate. For such an embodiment, the optimal gas flow may be as shown in FIG. 5.

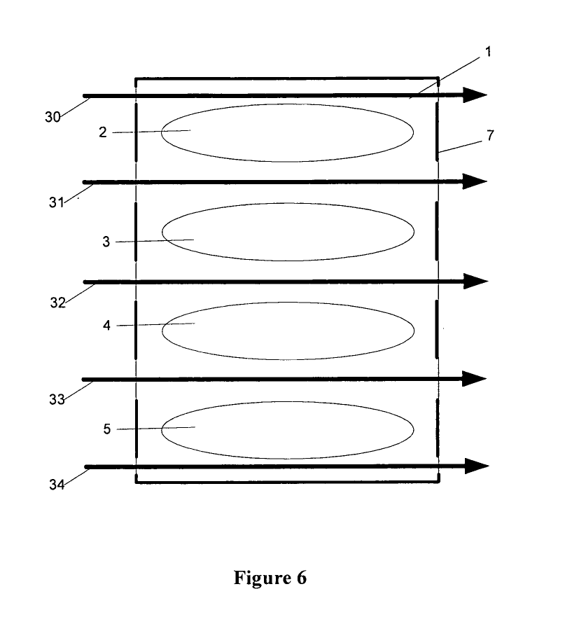

Referring now to FIG. 6, this schematically illustrates a further embodiment of the present invention. The embodiment of FIG. 6 is generally similar to that of FIG. 4, with the exception that the number of inlets and outlets has been increased such that gas is passed adjacent to every major surface of the lens elements 2-5, as depicted by arrows 30-34. The embodiment of FIG. 6 provides for a large degree of cooling as the surface area of each lens element that gas is passed over is increased by gas passing on both sides.

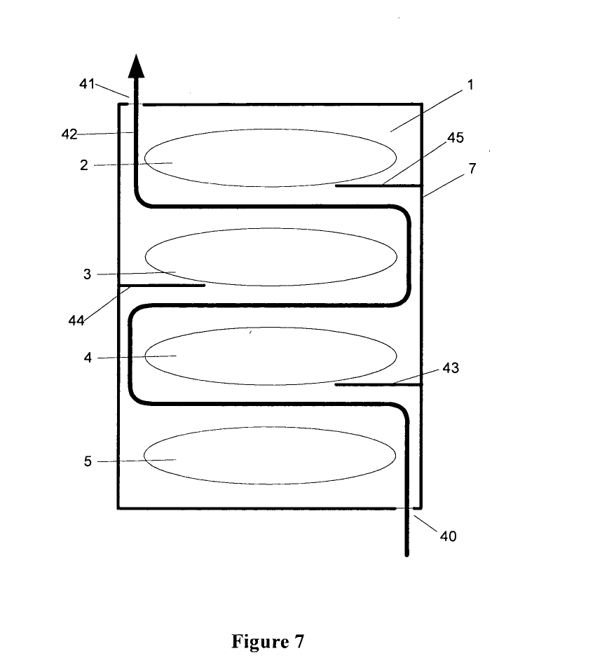

Referring to FIG. 7, this schematically illustrates a further embodiment of the present invention, in which there is a single inlet 40 and a single outlet 41. Gas is passed between in the inlet 40 and outlet 41 in a generally upwards direction as indicated by arrow 42. It can be seen that the inlet 40 and outlet 41 are arranged to be as far apart as possible, such that the air has to pass through a large proportion of the projection system, thus providing cooling substantially evenly throughout. Furthermore, in order to direct the gas to flow between each of the lens elements 2-5, baffles 43-45 are provided. It will be appreciated that alternative arrangements of baffles may be provided in order to change the flow of the gas. Furthermore, the positions of the inlet and outlet may be varied.

For a lithographic apparatus arranged for projecting the pattern of solder bumps for a flip chip bonding process typically a broadband projection beam, comprising a range of frequency components is used. This is in order to increase the intensity of the projection beam, and also because the required resolution is less than that for other lithographic apparatus. According to the material from which each lens element is formed, and the coating material applied to each lens element, the distribution of heating within each lens element and across the lens coating may alter. Suitable materials for the lens elements and the lens coatings include quartz, flint glass and CaF. Furthermore, the wavelength of the projection beam of radiation may affect the degree of lens heating, in combination with the lens and coating materials. As multiple wavelengths are present, it is difficult to optimize the lens and coating materials used, and as such the degree of lens heating can be much more significant than for other lithographic apparatus. For these reasons, a cooling system in accordance with the present invention is particularly advantageous.

The above described embodiments of the present invention can provide more effective temperature regulation for a projection system than known methods of cooling the exterior casing of a projection system. Due to the improved temperature regulation, mechanical compensation techniques such as lens manipulators may not be needed, resulting in cost and complexity reductions for the projection system. The software controlling lens movements may also be reduced in complexity due to less frequently required adjustments of lens positions. Reduced software complexity results in a more stable and passively constant projection system. Improved thermal regulation can also reduce the need for adjustment of the pattern imparted to the projection beam, thus resulting in a more efficient patterning system.

Due to the ability of the cooling system in accordance with embodiments of the present invention to cool a projection system more efficiently than known exterior casing cooling systems, the present invention may also provide the ability to use projection beams of radiation at higher intensities, which may be advantageous for certain applications.

In the above description, the flip-chip bumping process has been described in terms of the use of solder. The term ‘solder’ is intended to include any suitable metal or alloy, and includes (but is not limited to) Eutectic 63Sn/37Pb solder, high lead solder, 95Pb5Sn, Tin, SnCuAg, SnAg3.5 and SnCu. Other suitable materials may be used, and such materials will be known to those skilled in the art. The data could include an indication of which material is to be used for a given batch of substrates.

Although specific reference may be made in this text to the use of flip-chip bumping for ICs, it should be understood that the invention described herein may have other applications, such as flip-chip bumping for integrated optical systems, guidance and detection patterns for magnetic domain memories, liquid-crystal displays (LCDs), thin-film magnetic heads, etc. In general where the above description refers to an IC (or ICs, it will be understood that this is intended to include a device (or devices), which may or may not be an IC.

While specific embodiments of the invention have been described above, it will be appreciated that the invention may be practiced otherwise than as described. The description is not intended to limit the invention, and the invention is only limited by the claims that follow.

What is claimed is:

1. A lithographic apparatus comprising:
an illumination system configured to provide a beam of radiation;
a projection system configured to project the beam of radiation; and
a cooling system arranged to pass gas through the interior of the projection system such that the throughput of gas through the interior of the projection system is greater than 100 liters of gas per hour.

2. A lithographic apparatus according to claim 1, wherein the cooling system is arranged such that the throughput of gas through the interior of the projection system is greater than 1000 liters of gas per hour.

3. A lithographic apparatus according to claim 1, wherein the projection system comprises one or more lens elements surrounded by an outer casing, and the cooling system is arranged to pass gas through the interior of the projection system from a first portion of the outer casing to a second portion of the outer casing remote from the first portion.

4. A lithographic apparatus according to claim 3, wherein the cooling system is arranged to pass gas between the first portion and the second portion in a generally horizontal direction.

5. A lithographic apparatus according to claim 3, wherein the cooling system is arranged to pass gas between the first portion and the second portion in a generally vertical direction.

6. A lithographic apparatus according to claim 3, wherein the projection system further comprises one or more baffles arranged to deflect gas between the lens elements as the gas passes between the first portion and the second portion.

7. A lithographic apparatus according to claim 1, wherein the cooling system is arranged to cool the projection system.

8. A lithographic apparatus according to claim 1, wherein the apparatus further comprises a valve arranged to control the passage of gas to the projection system.

9. A lithographic apparatus according to claim 8, wherein the apparatus further comprises a controller which is connected to a flow meter and which controls the valve based on feedback from the flow meter.

10. A device manufacturing method comprising:
providing a beam of radiation using an illumination system;
projecting the beam of radiation with a projection system; and
passing gas through the interior of the projection system such that the throughput of gas through the interior of the projection system is greater than 100 liters of gas per hour.

11. A method according to claim 10, wherein the throughput of gas through the interior of the projection system is greater than 1000 liters of gas per hour.

12. A method according to claim 10, wherein the projection system comprises one or more lens elements surrounded by an outer casing, and the method further comprises passing gas through the interior of the projection system from a first portion of the outer casing to a second portion of the outer casing remote from the first portion.

13. A method according to claim 12, further comprising passing gas between the first portion and the second portion in a generally horizontal direction.

14. A method according to claim 12, further comprising passing gas between the first portion and the second portion in a generally vertical direction.

15. A method according to claim 12, further comprising deflecting gas between the lens elements as the gas passes between the first portion and the second portion.

16. A lithographic apparatus comprising:
an illumination system configured to provide a beam of radiation;
a projection system configured to project the beam of radiation, the projection system comprising one or more lens elements surrounded by an outer casing; and
a cooling system arranged to pass gas through the interior of the projection system, the cooling system being arranged such that the gas is directed through the interior of the projection system from a first portion of the outer casing to a second portion of the outer casing remote from the first portion.

17. A lithographic apparatus according to claim 16, wherein the cooling system is arranged to pass gas between the first portion and the second portion in a generally horizontal direction.

18. A lithographic apparatus according to claim 16, wherein the cooling system is arranged to pass gas between the first portion and the second portion in a generally vertical direction.

19. A lithographic apparatus according to claim 16, wherein the projection system further comprises one or more baffles arranged to deflect gas between the lens elements as the gas passes between the first portion and the second portion.

20. A lithographic apparatus according to claim 16, wherein the apparatus further comprises a valve arranged to control the passage of gas to the projection system.

21. A lithographic apparatus according to claim 20, wherein the apparatus further comprises a controller which is connected to a flow meter and which controls the valve based on feedback from the flow meter.

22. A device manufacturing method comprising:
providing a beam of radiation using an illumination system;
projecting the beam of radiation with a projection system, the projection system comprising one or more lens elements surrounded by an outer casing;
passing gas through the interior of the projection system with a cooling system; and
directing the gas through the interior of the projection system from a first portion of the outer casing to a second portion of the outer casing remote from the first portion.

23. A method according to claim 22, further comprising passing gas between the first portion and the second portion in a generally horizontal direction.

24. A method according to claim 22, further comprising passing gas between the first portion and the second portion in a generally vertical direction.

25. A method according to claim 22, further comprising deflecting gas between the lens elements as the gas passes between the first portion and the second portion.

26. A lithographic apparatus comprising:
an illumination system for providing a beam of radiation;
a projection system for projecting the beam of radiation; and
a cooling system arranged to pass gas through the interior of the projection system such that the cooling system cools the projection system.

27. A device manufacturing method comprising:
providing a beam of radiation using an illumination system;
projecting the beam of radiation with a projection system; and
passing gas through the interior of the projection system such that the gas cools the projection system.
